(19) United States
(12) Patent Application Publication
(10) Pub. No.: US 2013/0056488 A1
(43) Pub. Date: Mar. 7, 2013

(54) PLANETARY GEAR DRIVE CUP TURRET FOR CUP DROP UNIT IN BEVERAGE VENDING MACHINE

(71) Applicant: Matthew Hooper, Bristol (GB)

(72) Inventor: Matthew Hooper, Bristol (GB)

(73) Assignee: CRANE MERCHANDISING SYSTEMS, INC., Bridgeton, MO (US)

(21) Appl. No.: 13/595,772

(22) Filed: Aug. 27, 2012

Related U.S. Application Data
(60) Provisional application No. 61/527,811, filed on Aug. 26, 2011.

(51) Int. Cl. B65G 59/06

(52) U.S. Cl. 221/1; 221/122

(57) ABSTRACT

A cup turret carousel includes a gear drive track around a periphery thereof, to be driven by a planetary gear rather than being driven from the central axis and thereby reduce cost and achieve greater accuracy in aligning a cup turret with the cup funnel throat for cup delivery. The drive gear is maintained in a in a fixed position relative to a cup funnel throat through which cups pass when dropped, so that the same drive assembly may be employed with cup turret carousels of different diameters.

### CROSS-REFERENCE TO RELATED APPLICATIONS

This application claims priority to U.S. Provisional Patent Application Ser. No. 61/527,811 entitled “PLANETARY GEAR DRIVE CUP TURRET FOR CUP DROP UNIT IN BEVERAGE VENDING MACHINE” and filed on Aug. 26, 2011 (Attorney Docket CRAN01-00538). The content of the above-identified patent document is incorporated herein by reference.

### TECHNICAL FIELD

The present application relates generally to drive systems for a cup turret in beverage vending machines and, more specifically, to accurate and scalable cup turret drive systems.

### BACKGROUND

Cup beverage vending machines, such as vending machines that dispense cups of hot beverages, often at least optionally provide a cup to the purchaser. Cups are stored in a rotatable cup turret, which holds multiple stacks of cups of the same or different sizes, and dropped from the turret to a delivery station, where a beverage is dispensed into the cup. Cup turret assemblies including multiple turrets are rotated to align an individual turret with the funnel throat through which a cup dispensed from the respective turret passes.

Historically cup turret assemblies with multiple turrets have used a drive mechanism that operates on (provides driving force to) a central axis or pin in order to effect rotation. However, such drive mechanisms suffer from problems relating to (a) the accuracy of the angular position (the amount of rotation relative to a reference orientation) required to align a turret with the funnel throat, and (b) in cups turrets that dispense cups of different diameters or between two cup turrets that dispense cups of different diameters, accommodating differences in the distance between the central axis and the funnel throat. Various mechanisms proposed or implemented to address those issues have significantly increased the cost of the drive assembly and/or cu turret assembly.

There is, therefore, a need in the art for an improved cup turret drive assembly in a cup beverage vending machine.

### SUMMARY

A cup turret carousel includes a gear drive track around a periphery thereof, to be driven by a planetary gear rather than being driven from the central axis and thereby reduce cost and achieve greater accuracy in aligning a cup turret with the cup funnel throat for cup delivery. The drive gear is maintained in a in a fixed position relative to a cup funnel throat through which cups pass when dropped, so that the same drive assembly may be employed with cup turret carousels of different diameters.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of portions of an assembled cup turret planetary gear drive assembly for a cup drop unit within a cup beverage vending machine according to one embodiment of the present disclosure;

FIG. 2 is a perspective view of the cup turret planetary gear drive assembly of FIG. 1 with the cup turret carousel support plate removed;

FIG. 3 is a perspective view similar to that of FIG. 2, but with a cover removed;

FIG. 4 is a perspective view of the cup turret planetary gear drive assembly of FIG. 1, with a cup turret carousel and cup turret mounted thereon;

FIGS. 5 and 6 depict portions of a drive mechanism within the cup turret planetary gear drive assembly of FIG. 1;

FIG. 7 illustrates an adjustable pin within the cup turret planetary gear drive assembly of FIG. 1; and

FIG. 8 illustrates, from a bottom perspective, the cup turret planetary gear drive assembly of FIG. 1.

### DETAILED DESCRIPTION

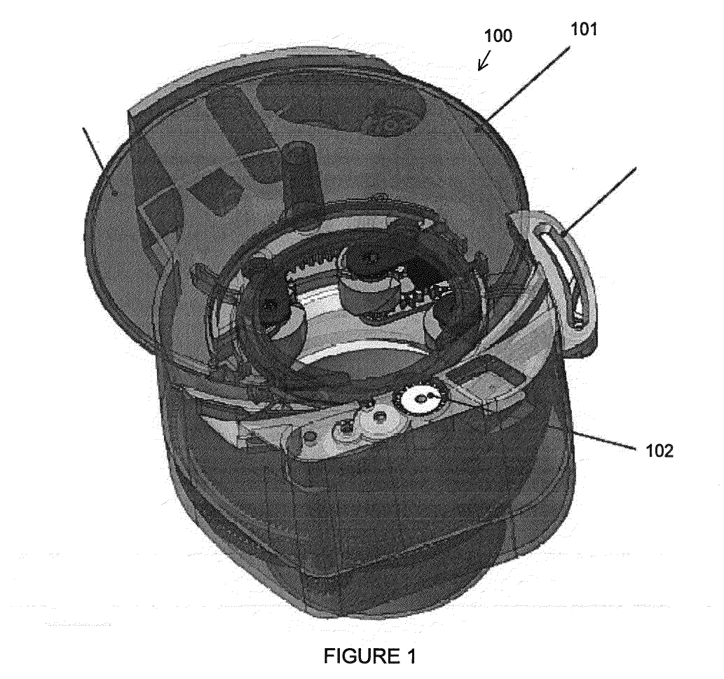

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine system.

A cup turret carousel is driven by a planetary (peripheral) gear, so that a small gear (e.g., 20 teeth) drives a much larger gear track (e.g., 220 teeth) around a periphery of the cup turret carousel. This allows each cup turret to be aligned with the funnel throat much more accurately. No issue with speed of rotation is created; existing designs using a central drive typically need to be heavily geared down to drive slowly (e.g., 1-2 revolutions per minute).

FIG. 1 is a perspective view of portions of an assembled cup turret planetary gear drive assembly for a cup drop unit within a cup beverage vending machine according to one embodiment of the present disclosure. The drive assembly 100 includes a turret carousel support plate 101 is mounted for rotation about a central axis. A drive gear 102 is located to drive a peripheral gear track on the cup turret carousel (not shown in FIG. 1).

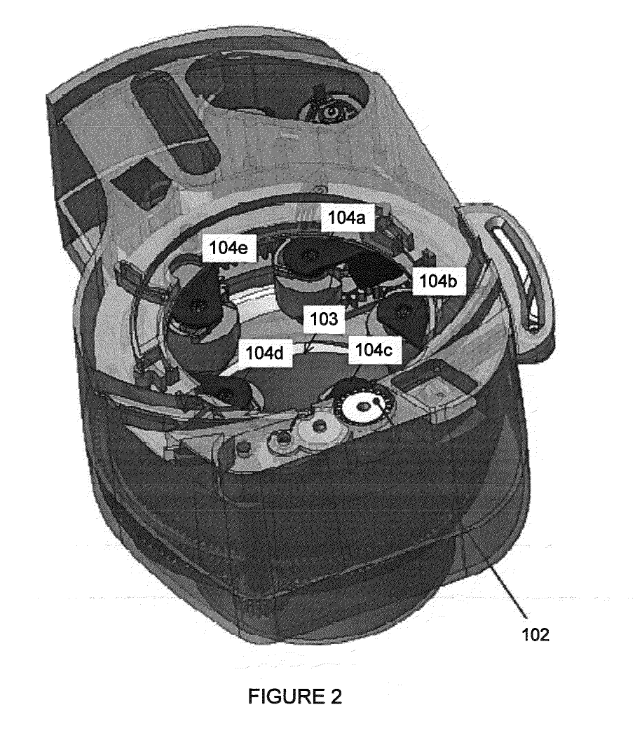

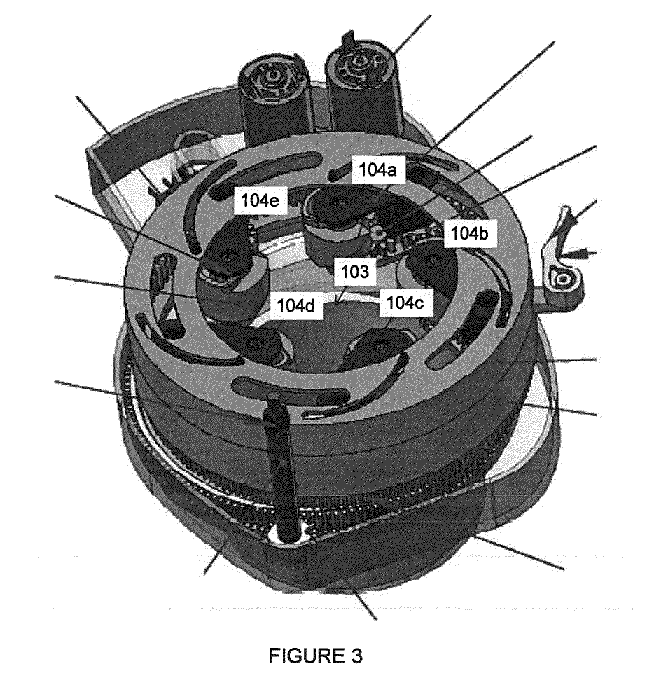

FIGS. 2 and 3 are perspective views of the cup turret planetary gear drive assembly of FIG. 1 with the cup turret carousel support plate removed in FIG. 2 and with the cup turret carousel support plate, an external cover and portions of the drive system removed in FIG. 3. The cup funnel throat 103, with adjustable cup guide mechanisms 104a-104e located around a periphery of the throat 103, is shown, through which cups are dropped from a cup turret rotated to be positioned above the funnel throat. Cup guide mechanisms 104a-104e are adjustable in accordance with known structures and techniques, to accommodate cups of different diameters (e.g., 55 mm to 95 mm cups, or 2.5 inch to 3.75 inch cups).

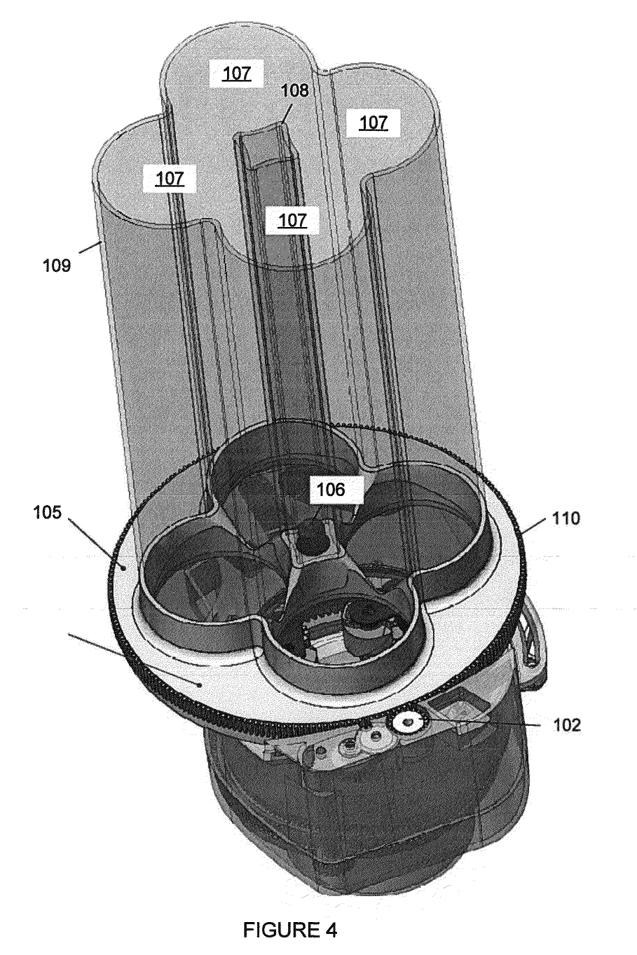

FIG. 4 is a perspective view of the cup turret planetary gear drive assembly of FIG. 1, with a cup turret carousel and cup turret mounted thereon. Cup turret carousel 105 is supported by and, in the example shown, rotates freely around a projection 106 from the center of, the support plate 101 (only portions of which are visible in FIG. 4). Cup turret carousel 105 includes a gear track 110 around a periphery thereof engaging with drive gear 102.

The cup turrets 107 are secured to and supported by the cup turret carousel 105. In the example depicted, a central separator 108 and a peripheral housing 109 form four cup turrets 107, each of which can hold one stack of cups. The cup turrets 107 may be configured to hold cups of the same size or of different sizes, or some permutation thereof (e.g., one turret for a first size, while the remaining three all hold cups of a second size different than the first).

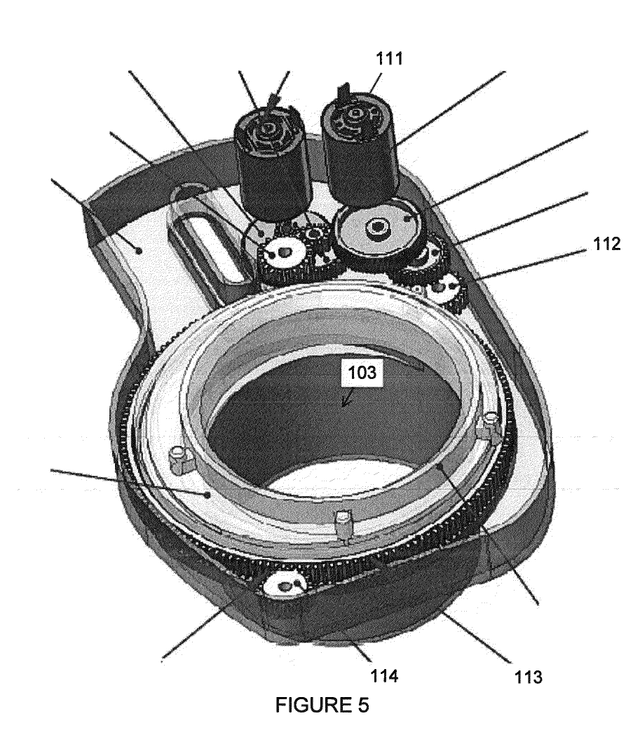

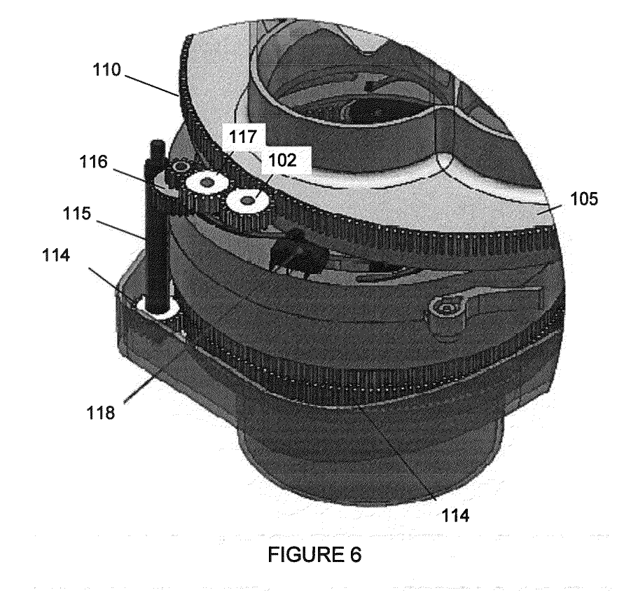

FIGS. 5 and 6 depict portions of a drive mechanism within the cup turret planetary gear drive assembly of FIG. 1. A motor 111 drives the drive gear 102. (A separate motor, also shown in FIG. 5, drives other movable components such as the adjustable guide mechanisms 104a-104e described above). In the example shown, the motor 111 drives a first gear on one side of the funnel throat 103, which drives a large transfer gear 113 around the throat 103, which then drives a transfer gear on the opposite side of throat 103. Additional transfer shafts and gears 115, 116 and 117 then transfer the drive force to the drive gear 102. This arrangement is used in the exemplary embodiment to position the motor in a space available given other physical requirements, and to maintain the drive gear in a fixed position relative to the throat despite adjustment of the point of rotation for the cup turret carousel 105 as described above. A microswitch 118 adjacent to the cup turret carousel 105 counts passage of ridges on the underside of the cup turret carousel to verify the angular orientation of the cup turret carousel 105. The ridges may be spaced according to the number of cup stacks on the cup turret carousel 105.

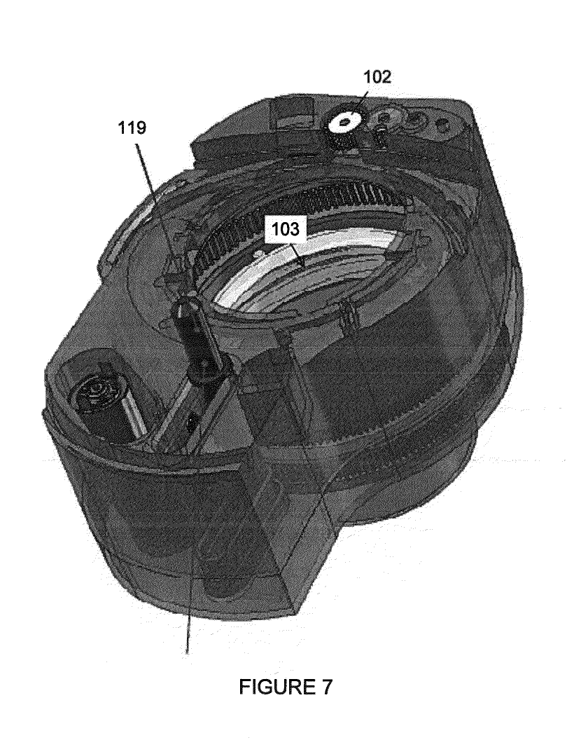

FIG. 7 illustrates an adjustable pin within the cup turret planetary gear drive assembly of FIG. 1. It is desirable to use the same drive assembly in cup beverage vending machines of different sizes—for example, in tabletop cup beverage vending machines as well as free-standing cup beverage vending machines. As will be apparent, the tabletop vending machine is small compared to the free-standing machine, and will use a smaller carousel having fewer cup turrets and holding fewer cups. For example, a small carousel of about 12 inches in diameter might support only 4 cup stacks, each in a separate turret. A larger carousel of 16 inches or more might support 10 cup turrets, depending on cup sizes (e.g., smaller cups for a 5 ounce beverage than for larger beverages).

In the design of the present disclosure, cup turret carousels of different sizes are driven using the same drive assembly 100. An adjustable pin 119 that may be moved closer to or further away from the center of funnel throat 103 allows the different size cup turret carousels to be mounted on the drive assembly, while keeping the position of the drive gear 102 fixed relative to the funnel throat 103.

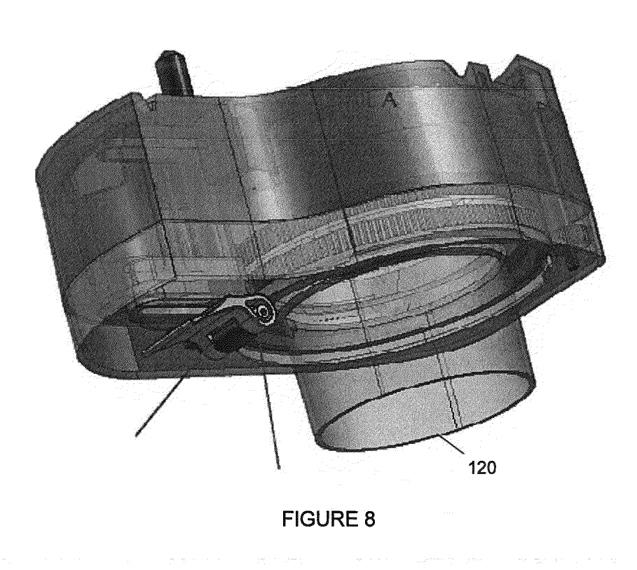

FIG. 8 illustrates, from a bottom perspective, the cup turret planetary gear drive assembly of FIG. 1. The cup funnel 120 through which dropped cups pass is visible in this view.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A cup turret assembly, comprising:
a cup turret carousel configured to support a cup turret, the cup turret carousel having a drive coupling structure at a periphery of the cup turret carousel; and
a drive mechanism configured to engage the drive coupling structure and to selectively cause rotation of the cup turret carousel.

2. The cup turret assembly according to claim 1, wherein the drive mechanism includes a gear having fewer gear teeth than are located around the periphery of the cup turret carousel.

3. The cup turret assembly according to claim 1, wherein the drive mechanism is controlled to position a cup stack within the cup turret over a cup funnel throat configured to guide a cup into a cup delivery path.

4. The cup turret assembly according to claim 3, wherein the cup funnel throat includes one or more adjustable cup guide mechanisms configured to be adjusted based on delivery from the cup turret of cups of different diameters.

5. The cup turret assembly according to claim 1, wherein an axis of rotation about which the cup turret carousel rotates may be translated relative to a position of a cup funnel throat into which cups are delivered.

6. The cup turret assembly according to claim 5, wherein the drive mechanism further comprises:
a drive gear engaging drive teeth around a periphery of the cup turret carousel;
a transfer gear positioned around the cup funnel throat; and
a motor coupled to the transfer gear, wherein the drive gear remains in a position fixed relative to the position of the cup funnel throat despite movement of the axis of rotation about which the cup turret carousel rotates relative to the position of a cup funnel throat.

7. The cup turret assembly according to claim 1, further comprising:
at least two cup turrets mounted to the cup turret carousel, wherein a first of the cup turrets holds cups of a first diameter and wherein a second of the cup turrets holds cups of a second diameter different than the first diameter.

8. The cup turret assembly according to claim 1, further comprising:
ridges at spaced intervals on a surface of the cup turret carousel; and
a microswitch engaging the ridges and providing a signal indicating an angular orientation of the cup turret carousel.

9. A method, comprising:
supporting a cup turret on a cup turret carousel having a drive coupling structure at a periphery of the cup turret carousel; and
driving the cup turret carousel using a drive mechanism engaging the drive coupling structure and to selectively cause rotation of the cup turret carousel.

10. The method according to claim 9, wherein the drive mechanism includes a gear having fewer gear teeth than are located around the periphery of the cup turret carousel.

11. The method according to claim 9, further comprising:
controlling the drive mechanism to position a cup stack within the cup turret over a cup funnel throat configured to guide a cup into a cup delivery path.

12. The method according to claim 9, further comprising
adjusting one or more adjustable cup guide mechanisms in the cup funnel throat based on delivery from the cup turret of cups of different diameters.

13. The method according to claim 9, further comprising:
translating an axis of rotation about which the cup turret carousel rotates relative to a position of a cup funnel throat into which cups are delivered.

14. The method according to claim 13, wherein the drive mechanism comprises a drive gear engaging drive teeth around a periphery of the cup turret carousel, a transfer gear positioned around the cup funnel throat and a motor coupled to the transfer gear, the method further comprising:
maintaining the drive gear in a position fixed relative to the position of the cup funnel throat despite movement of the axis of rotation about which the cup turret carousel rotates relative to the position of a cup funnel throat.

15. The method according to claim 9, further comprising:
holding cups in at least two cup turrets mounted to the cup turret carousel, wherein a first of the cup turrets holds cups of a first diameter and wherein a second of the cup turrets holds cups of a second diameter different than the first diameter.

16. The method according to claim 1, further comprising:
providing a signal indicating an angular orientation of the cup turret carousel by sensing passage of ridges at spaced intervals on a surface of the cup turret carousel past a microswitch engaging the ridges.

17. A cup turret assembly, comprising:
a structure including one or more cup turrets;
a cup turret carousel configured to support the cup turrets, the cup turret carousel having a planetary gear track around periphery of the cup turret carousel; and
a drive gear configured to engage the planetary gear track and to selectively cause rotation of the cup turret carousel and the one or more cup turrets to position one of the cup turrets over a cup funnel throat through which cups enter a cup delivery path, the drive gear having fewer teeth than the planetary gear track.

18. The cup turret assembly according to claim 17, wherein the cup turret carousel includes a support plate having projection at a center thereof, the support plate rotating about the central projection.

19. The cup turret assembly according to claim 17, wherein at least one of the cup turrets holds cups of a size different from a size of cups held by another of the cup turrets, and wherein the cup turret carousel and cup turrets are translated relative to a position of the cup funnel throat to accommodate the differences in cup sizes.

20. The cup turret assembly according to claim 19, wherein the drive gear remains in a position fixed relative to the cup funnel throat.
